(19) United States
(12) Patent Application Publication
(10) Pub. No.: US 2016/0073575 A1
(43) Pub. Date: Mar. 17, 2016

(54) SEEDING MACHINE

(71) Applicant: Aldo SPAPPERI, Citta' di Castello (PG) (IT)

(72) Inventor: Aldo SPAPPERI, Citta' di Castello (IT)

(21) Appl. No.: 14/784,967

(22) PCT Filed: Mar. 13, 2014
(86) PCT No.: PCT/IB2014/059723

§ 371 Date: Oct. 16, 2015

(30) Foreign Application Priority Data
Apr. 17, 2013 (IT) PG2013A000017

(51) Int. Cl. A01C 7/00; A01C 5/04

(52) U.S. Cl. CPC A01C 7/002; A01C 5/04

(57) ABSTRACT

The present invention refers to a machine for laying seeds (or grains), in particular in cultivations providing the use of a plastic film for protection of the seeded soil or ground.

The present invention refers to a machine for laying seeds (or grains), in particular in cultivations providing the use of a plastic film for protection of seeded soil or ground.

Usually, in open-field cultivation of some grains, above all after seeding, a high input of water is required. Ever scarcer availability of water, associated with ever increasing watering costs, significantly burdens the economic result of the aforesaid crops. In this respect, costs related to interventions for defense against weeds, with suitable equipment or specific products, are not insignificant either. To limit cultivation end costs attributable to the aforesaid interventions, the growing technique providing plastic film use (hereinafter referred to as ‘mulching’) to cover and protect ground where different grain varieties are laid is becoming increasingly widespread.

The advantage of this system lies in that between film and earth a condensation-rich zone rich in condensation is created, keeping the ground moist and therefore fostering plant growth. Another advantage of crops under mulching is that near the plant, if the film remains sufficiently adherent to the stalk, there is no weed growth.

Seed laying on mulched ground is currently carried out on a mechanized level with machines that, by seed-carrying pincers, sequentially pierce the film and simultaneously lay seeds into the ground. The known problem is that when the transplanting distance of seeds on the same row is very small, and since pincers to be able to open and close have a minimum constructive encumbrance, it happens that the cut produced by the pincers themselves onto the film to plant the seed into the ground has a size such as to almost unite with the next one; this causes (a phenomenon oft-times also amplified by wind) substantial cuts which eventually thwart the effect that had to be obtained by mulching, i.e. water saving and the avoiding of treatments for preventing weed growth near the plant, with evident losses from an economic standpoint.

Object of the present invention is therefore to provide an innovative solution to the problems left still open by the known art, by providing a seeding machine as defined in independent claim 1.

Secondary features of the present invention are instead defined in the corresponding dependent claims thereof.

As will be illustrated hereinafter in this description, the present invention entails several advantages. In particular, the machine according to the invention comprises a nozzle-carrying wheel that, by rolling onto the film—driven by the contact of the same nozzles onto the ground—deposits at a required depth the grains collected by suction from the relevant hopper, making a hole into the film that is not much greater than the size of the seed to be laid. This ensures first of all an optimal protection of the seed and the preserving of a condition of integrity of the plastic film.

These and further advantages, as well as the features and operation steps of the present invention, will be made apparent in the following detailed description of embodiments thereof, given by way of example and not for limitative purposes. Reference will be made to the figures of the annexed drawings, wherein:

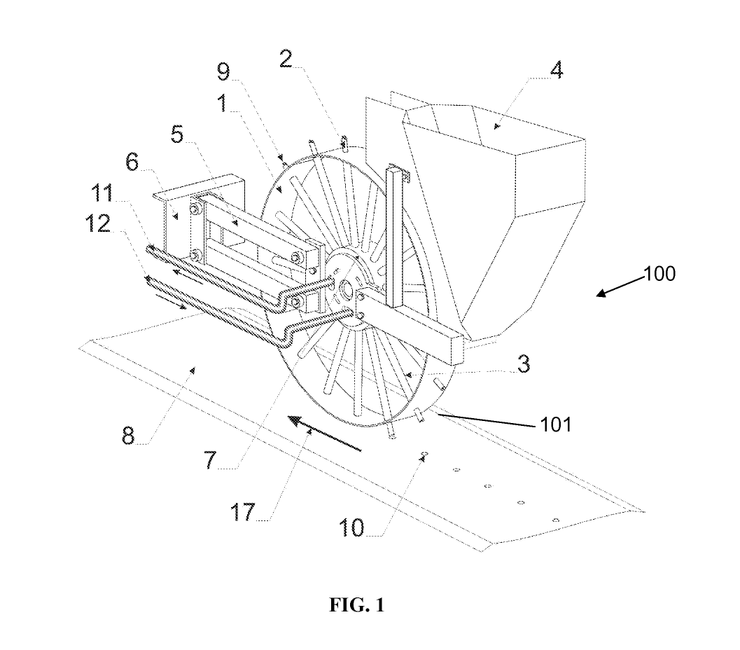

FIG. 1 is a perspective view of a machine according to one embodiment of the present invention;

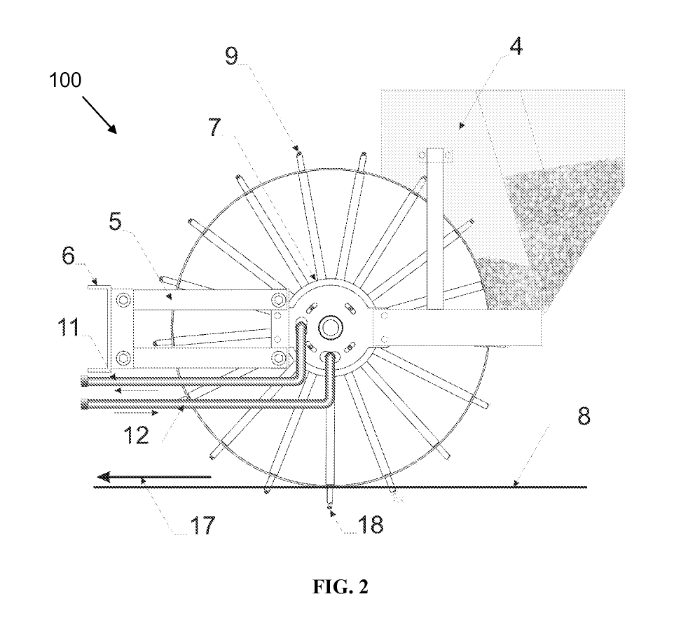

FIG. 2 is a side view of a machine according to one embodiment of the present invention;

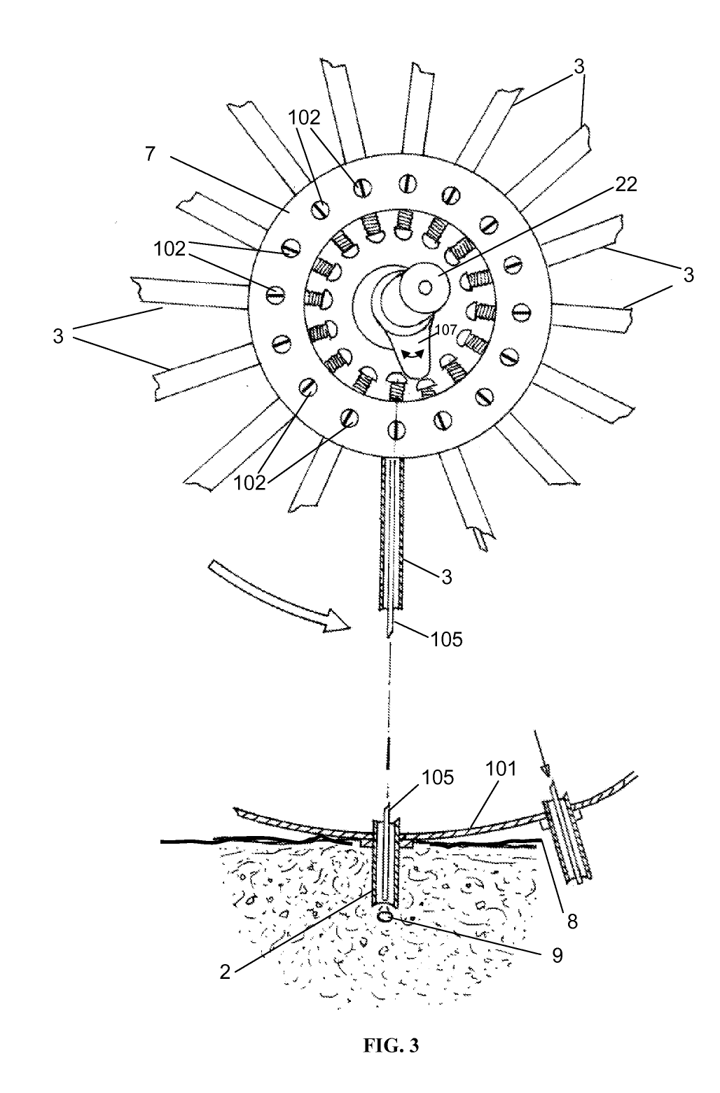

FIG. 3 is a view of the interior of a hub of a wheel of a machine according to one embodiment of the present invention;

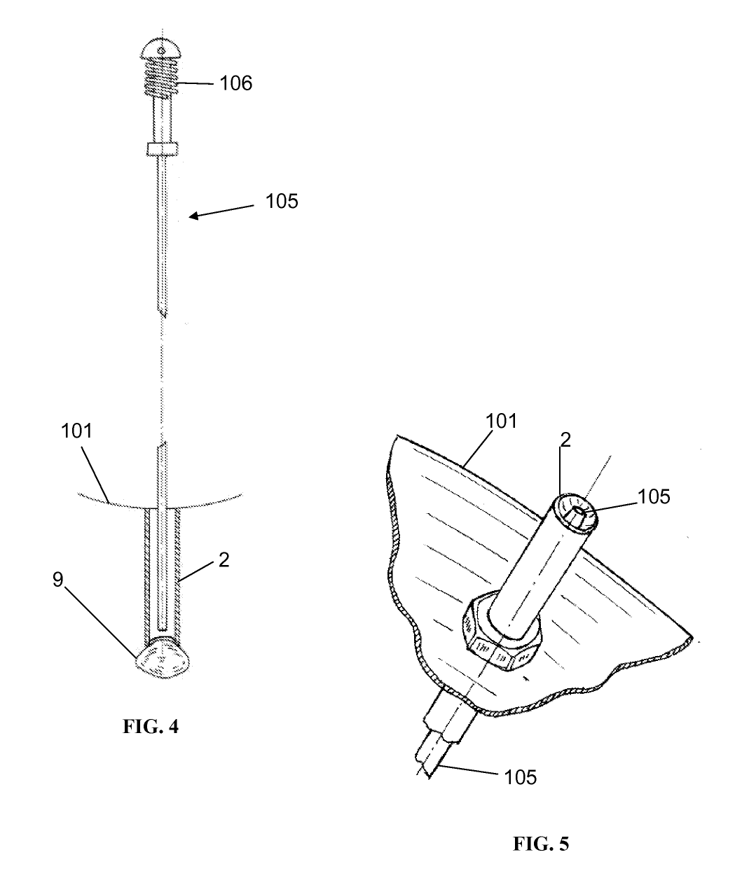

FIG. 4 is a view of an elongated member for unclogging the cavity of a spoke and of a nozzle;

FIG. 5 is a view of a detail showing a seeding nozzle, from which an unclogging member projects;

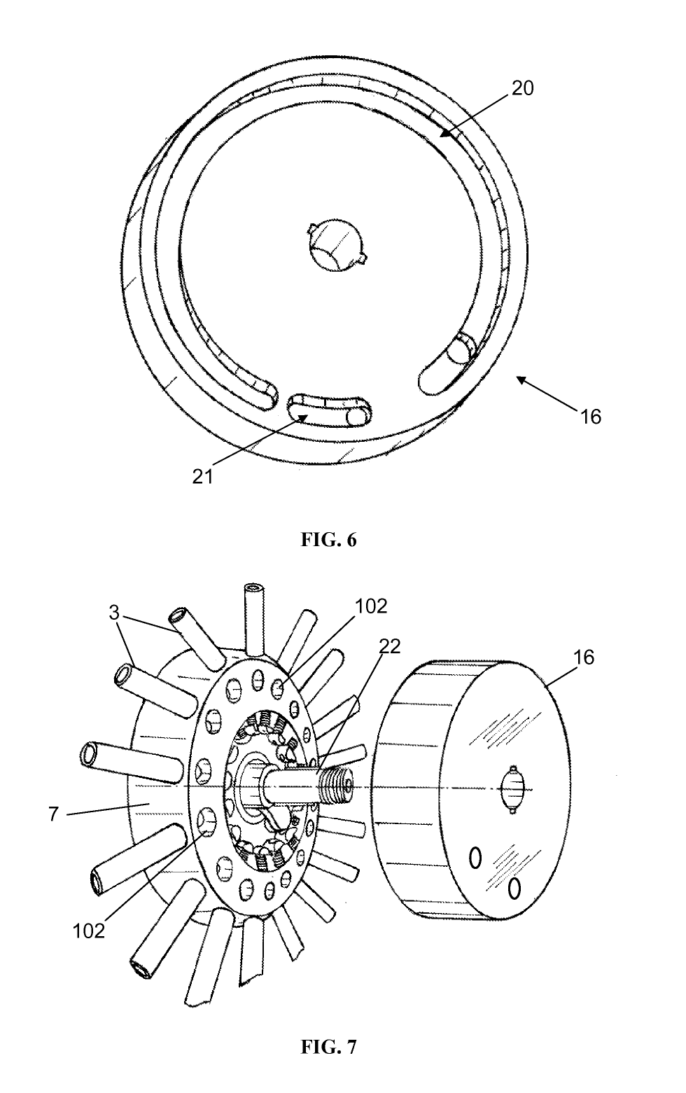

FIG. 6 is a view showing the interior of a dispenser according to one embodiment of the present invention;

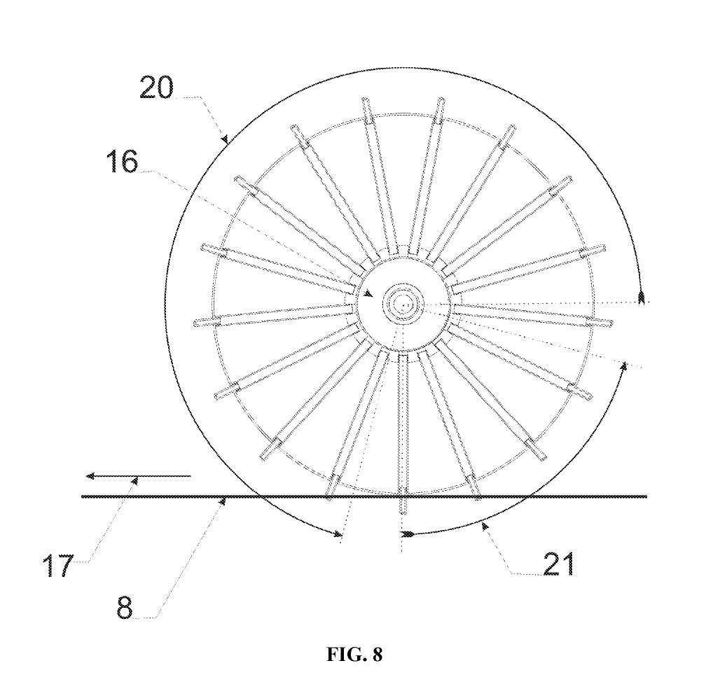

FIG. 7 is a view showing the positioning of the dispenser on the pivot of the wheel;

FIG. 8 is a side view of a wheel of a machine according to one embodiment of the present invention;

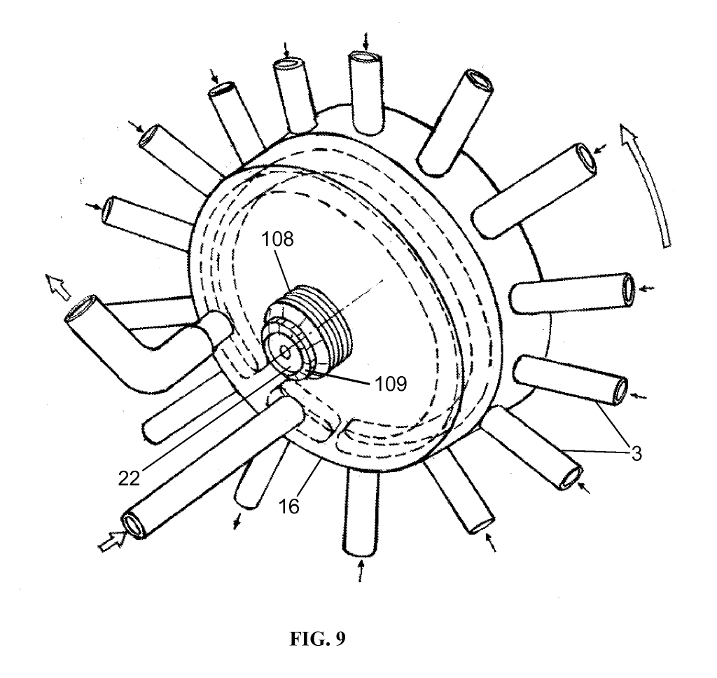

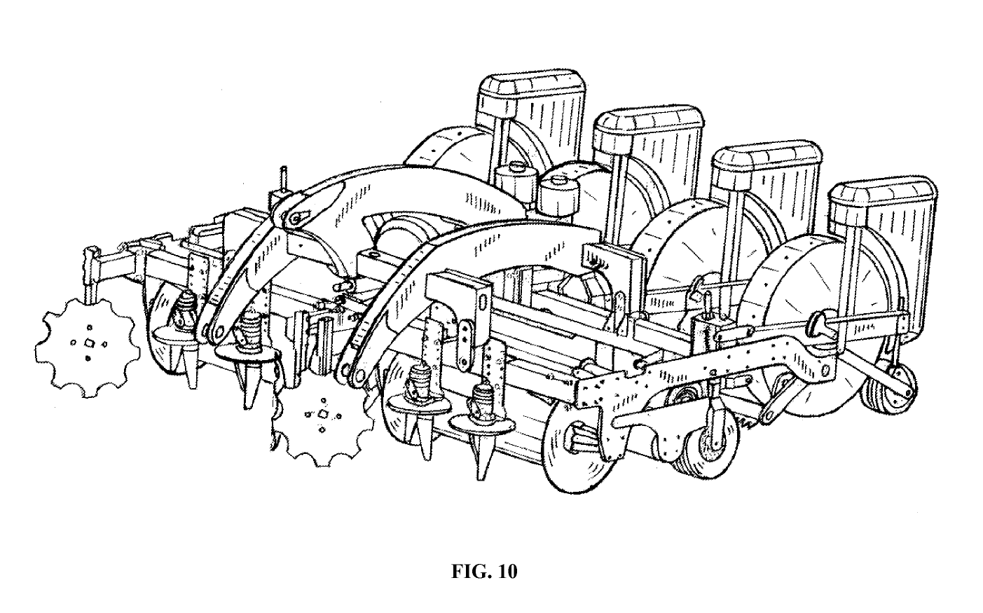

FIG. 9 is a view showing the dispenser coupled and secured to the pivot of the wheel; and

FIG. 10 is a view of a machine according to a further embodiment of the present invention.

The present invention will hereinafter be described in detail, making reference to the above-indicated figures.

Referring initially to FIG. 1, it shows one embodiment of a machine according to the present invention.

In particular, a machine 100 for laying seeds, particularly useful in cultivations providing the use of a plastic film 8 for protection of the seeded soil, is shown.

According to the invention, the machine 100 comprises at least one storage tank 4 for seeds to be laid.

Moreover, the machine 100 comprises at least one free wheel 1. By “free wheel” it is meant that the wheel is not set in rotation by a motor, but is free to rotate about its own axis. In particular, according to the invention, the machine is hauled and the wheel is set in rotation by contact with the ground.

According to the embodiment described herein, the wheel 1 has a peripheral portion 101, e.g. a belt, that, in use, is in contact with the film 8 placed on the soil.

Said peripheral portion carries seeding means that are adapted to, during the rolling of the wheel on the soil, collect seeds 9 from the storage tank 4, make holes 10 on the film 8 at regular intervals, and lay the collected seeds 9 at said holes 10, at a given depth in the soil.

Advantageously, the film-piercing and seed-laying operations take place substantially simultaneously.

The machine 100 provides such seeding means to comprise a plurality of projecting elements 2, which project from the peripheral portion of the wheel for a measure equal to the depth at which it is desirable to lay the seed.

Moreover, said projecting elements 2 are angularly equispaced along said portion, so as to make holes and lay the seeds always at a same distance the one from the other.

Advantageously, each of the projecting elements 2 comprises a hollow nozzle adapted to hold at least one seed 9 collected from the tank and release it when it lies within a hole 10 made on the film 8.

The tank 4 is preferably comprised of two zones divided by an adjustable bulkhead enabling to meter the amount of seeds that has to pass from the rear product-loading zone to that of seed collection by the nozzles 2. The front portion of the tank has lateral sides that have a same profile relative to the sheet metal of the peripheral portion of the wheel, and have a gasket-fitted slot; nozzles can go into said slot during a rotation of the wheel itself. In the bottom part of the tank, suitable brushes and gaskets prevent seeds from falling as nozzles go past.

According to one embodiment, the wheel 1 of the machine comprises a hub 7 to which hollow spokes 3 of the wheel are connected, each spoke 3 being in the region of one of the nozzles 2 and in communication therewith, to form substantially a single hollow duct.

Moreover, the hub 7 comprises connecting means for the connection of a suction device (not shown in the figures) and of a blowing device (not shown in the figures).

Said connecting means comprises a dispenser 16, visible in FIGS. 6 and 7, adapted to define a suction sector 20 to which a first plurality of spokes 3 corresponds, and a compression sector 21 to which one or more of said spokes 3 correspond.

The figures show how the hub has holes 102 putting in communication the cavities of the spokes with the suction and compression sectors defined by the dispenser 16 itself.

Accordingly, during the rolling of the wheel on the ground, some spokes are crossed by an air flow in a periphery-to-center direction. Preferably, as e.g. sketched in FIG. 8, the suction sector simultaneously involves all spokes 3—and therefore the nozzles 2—which during rotation go from the entry into the storage tank, for a width of about 270°, to the contact with the ground. The dispenser 16 is in fact such that, near the ground, always in the rolling direction of the wheel, the suction flow into the spokes be interrupted, to become a compression flow at the point in which the nozzle 2 lies within the hole made on the film 8 and therefore in a position such as to be able to lay the seed 9.

Upon passing this point, the nozzle will have effectively released the seed, therefore being substantially ready to again collect and hold another one from the tank.

In order to ensure a correct cleaning of the nozzles' cavities, it may be advantageous that the sector under compression be such as to involve not only the seed-laying spoke, but also some of the next spokes (always relative to the direction of rotation of the wheel) and which have already released the seed they carried.

The air flow exiting the nozzles can thus carry away any foreign body and/or soil residue remaining in the nozzle cavity after contact with the ground.

As visible in FIG. 9, the dispenser 16 is splined on the pivot 22 that constitutes the axis of rotation of the wheel, and coupled with the hub 7. The dispenser is fixed to the pivot 22, e.g. by one or more keys fitted onto the pivot itself.

The dispenser is preferably made of plastic material, or of Teflon, however of a material having basically a low friction coefficient. In fact, it should be such as not to hinder hub rotation. To this end, of course it has to be provided that the respective surfaces into contact (of the dispenser and the hub) be as smooth and uniform as possible.

This also in order to maintain a sufficient degree of sealing for suction and/or compression air. To cause the dispenser to be firmly in contact with the hub—precisely to guarantee the right sealing—yet concomitantly not offering particular resistance to the sliding of the hub onto its surface, it is advantageously provided that the dispenser be held on the axis through a spring 108, e.g. a disk spring, whose elastic force may be adjusted, e.g. by a threaded ring 109, so as to obtain the correct matching between the two pieces.

Advantageously, to further improve the nozzle-unclogging effect, according to one embodiment, the wheel comprises further means for unclogging (clearing) the cavity of the nozzles, also suitable to facilitate release of the seed during its laying.

Referring to FIGS. 3 to 5, such unclogging means comprises, for each spoke, a corresponding elongated member 105, e.g. a rod, running within the spoke 3 and connected to the hub so as to have an axial displacement relative to the spoke, such as to allow the coming out of one of its ends through a corresponding nozzle.

The rod 105 is advantageously built and assembled with a certain tolerance relative to the internal diameter of the spoke cavity, so as to simultaneously enable also transit of air to the outside, therefore allowing a combined mechanical and pneumatic cleaning function.

FIG. 5 shows precisely the detail of a nozzle 2 from which one end of a corresponding rod 105 comes out.

In particular, each of the elongated members 105 comprises an elastic return device 106, e.g. a spring, that returns it, at rest, completely inside the corresponding spoke/nozzle.

The wheel hub internally comprises a cam member 107 adapted to actuate, during the rolling of the wheel, one of the elongated members, in particular the nozzle that, over time, has just released the seed in the hole in the ground. It is evident how the action of the rod 105 is such as to facilitate detachment of any residue that may clog the nozzle and therefore prevent a correct subsequent operation thereof, i.e. the correct collecting of a further seed from the tank.

The cam member 107 is advantageously adjustable in its angular position, through a rotary motion about the wheel axis, just to enable to establish which nozzle, and at which instant, has to be involved by the unclogging action by the elongated member.

It is also evident that when the cam is adjusted so as to involve the nozzle that has to deposit the seed into the ground, the action of the elongated member would also serve to facilitate detachment of the seed from the nozzle, and therefore its positioning inside the hole made by the nozzle itself on the film and in the underlying ground.

In light of the above, hereinafter the operation of a machine according to the present invention is described.

When the wheel 1 is dragged on the protection film 8 already laid on the ground, the seed-carrying nozzles 2, by resting on the film 8, pierce it and begin to lodge themselves in the ground for all of their projection, concomitantly setting into rotation the wheel that will rest on the film 8 at the peripheral containment belt. Advantageously, wheel pressure on the film could be adjusted, e.g. through adjustment springs in the parallelogram 5, or by adding an additional spare wheel in the rear part.

Simultaneously with the wheel motion, according to what described hereto, suction flow and compression flow inside the spokes are always active.

The nozzles 2 have, in their end portion, a small hole proportioned to the grain to be treated, and exhibit a concave housing to foster accommodation of the seed 9 and also to facilitate film tearing by the peripheral edge of the end of the nozzle.

The nozzle 2, when crossing the front portion of the tank 4, lies in the suction sector 20 and therefore, pushing its way among the seeds it passes through, draws one seed and holds it up to the point in which the nozzle 2 contacts the soil.

Then, the nozzle pierces the film 8, introduces the seed into the ground and, in the meantime, the same nozzle comes into the compression sector 21. This compression stage is very important, as it enables to avoid that the nozzles may clog up with dust and debris.

Immediately after release of seed, the cam 107 inside the hub actuates the corresponding elongated member 105 which, by projecting from the free end of the nozzle 2, further facilitates seed detachment and release, and provides a complete and safe removal of any residue that might somehow have gotten stuck into the concave mouth of the nozzle.

Advantageously, the nozzles 2 may be interchangeable. This allows to adapt the machine to different seed typologies, according to their size, weight, etc.

To vary the seeding distance it is possible to replace the wheel by removing it from the pivot 22, whereas all the rest remains unvaried, or it is possible to make more holes on the wheel, closing up the unused ones.

FIG. 10 shows, by way of example, a machine according to the invention.

According to said embodiment, the machine further comprises the apparatuses for spreading out the protective film 8 on the ground, before the nozzle-carrying wheel may act to conclude the film-piercing and seed-laying operation.

The machine depicted comprises, by way of example, four seeding wheels, so as to be able to spread out a film and lay seeds simultaneously on four parallel rows.

The present invention has hereto been described with reference to preferred embodiments thereof. It is understood that the technical solutions implemented in the various embodiments, described herein by way of example, could advantageously be differently combined thereamong to give shape to other embodiments concerning the same inventive concept, all however falling within the protective scope defined by the claims set forth hereinafter.

1. A machine (100) for laying seeds (9) in cultivations providing the use of a plastic protective film (8) for protection of seeded soil or ground, comprising at least one storage tank (4) for said seeds; and at least one free wheel (1) having a peripheral portion (101) that, in use, is into contact with the film (8) placed on the ground; said peripheral portion (101) carrying seeding means adapted to, during the rolling of the wheel on the ground, collect seeds (9) from said storage tank (4), make holes (10) in said film (8) at regular intervals, and lay the collected seeds (9) in the region of said holes (10), at a given depth in the ground.

2. The machine (100) according to claim 1, wherein said seeding means comprises a plurality of elements (2) projecting from said peripheral portion (101), angularly equispaced along said portion, said elements projecting from the peripheral portion for a measure equal to said given depth.

3. The machine (100) according to claim 2, wherein each of said projecting elements comprises a hollow nozzle (2) adapted to hold at least one seed (9) collected from the tank and to release it when it lies within a hole (10) made on the film (8).

4. The machine (100) according to claim 3, wherein said wheel (1) comprises a hub (7) to which hollow spokes (3) of the wheel are connected, each spoke (3) being in the region of one of said nozzles (2) and in communication therewith.

5. The machine (100) according to claim 4, wherein said hub (7) comprises connecting means (11, 12) for the connection of a suction device and of a blowing device, and a dispenser (16) adapted to define a suction sector (20) to which a first plurality of spokes (3) corresponds, and a compression sector (21) to which one or more of said spokes (3) correspond.

6. The machine (100) according to claim 4, wherein said wheel (1) comprises means for unclogging the cavity of said nozzles (2), further suitable to facilitate release of the seed (9) during its laying.

7. The machine (100) according to claim 6, wherein said means for unclogging comprises, for each spoke (3), a corresponding elongated member (105), running within the spoke (3) and connected so as to have an axial displacement relative to the spoke (3) such as to allow the coming out of one end thereof through a corresponding nozzle (2).

8. The machine (100) according to claim 7, wherein each of said elongated members (105) comprises an elastic return device (106) that returns it, at rest, completely inside the corresponding spoke (3).

9. The machine (100) according to claim 7, wherein said hub (7) comprises a cam member (107), adjustable in its angular position, adapted to actuate, during the rolling of the wheel, one of the elongated members (105) so that one of its ends comes out of the corresponding nozzle (2).

10. The machine (100) according to claim 3, wherein said nozzles (2) are interchangeable, based upon the typology of seed to be laid.
